(19) United States
(12) Patent Application Publication
(10) Pub. No.: US 2006/0116945 A1
(43) Pub. Date: Jun. 1, 2006

(54) Apparatus of quantifying operational risk, and method therefor

(76) Inventor: Takeichiro Nishikawa, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/235,160

(22) Filed: Sep. 27, 2005

(30) Foreign Application Priority Data
Nov. 30, 2004 (JP) 2004-347805

(51) Int. Cl. G06Q 40/00

(52) U.S. Cl. 705/35

(57) ABSTRACT

An apparatus of quantifying operational risk includes a transaction amount input unit to input a transaction amount, a loss rate density input unit to input a loss rate density corresponding to a probability density when setting a loss rate in a loss event to a random variable, a massive loss density calculating unit to calculate a massive loss density of the loss rate density, which corresponds to an loss amount not less than a threshold, based on the transaction amount and the loss rate density, and a risk measure calculating unit configured to calculate operational risk from the massive loss density.

### CROSS-REFERENCE TO RELATED APPLICATIONS

This application is based upon and claims the benefit of priority from prior Japanese Patent Application No. 2004-347805, filed Nov. 30, 2004, the entire contents of which are incorporated herein by reference.

### BACKGROUND OF THE INVENTION

1. Field of the Invention

The present invention relates to an apparatus of quantifying operational risk based on a statistical procedure, and a method thereof.

2. Description of the Related Art

A new operational risk is introduced in regulations of new BIS (Bank for International Settlements). Conventional BIS regulations demand to set up an equity capital not less than 8% with respect to credit risk and market risk. In contrast, new BIS regulations demand to set up an equity capital of 8% with respect to a total of credit risk, market risk and operational risk. More precisely, the new BIS regulations demand to prepare for equity capital not less than 8% with respect to risk measure corresponding to VaR (value at risk) of 99.9% level.

One of a Basic Indicator Approach, a Standardised Approach and an Internal Measurement Approach may be employed in evaluation of risk measure. However, since precision of evaluation decreases with the former approach, evaluation with leeway is demanded, and thus the risk measure cannot but increase. Then, the equity capital must be raised corresponding to the risk. Generally, it is not desirable to take a cost on capital. Also, it is tied to preferable evaluation for shareholder that the risk is small and a capital adequacy ratio is high. Therefore, a bank has an incentive to introduce the advanced technique.

When the IMA (Internal Measurement Approach) is employed, the need to quantify reasonably the operational risk occurs. However, there is a problem that the accurate quantification is difficult because the number of past loss events is not enough. In particular, it is a problem that data of massive loss important for risk evaluation is small. Various methods are suggested to solve this problem, but it is the present conditions that a decisive method is not yet settled. Quantification of operational risk is described in, for example, “Entirely of operational risk”, Mitsubishi Trust & Banking Corporation operational risk study group, Orient economy newspaper company.

The object of the present invention is to provide an apparatus of quantifying operational risk of a massive loss from a few loss examples reasonably, and a method therefor.

### BRIEF SUMMARY OF THE INVENTION

An aspect of the present invention provides an apparatus of quantifying operational risk, comprising: a transaction amount input unit configured to input a transaction amount; a loss rate density input unit configured to input a loss rate density corresponding to a probability density of a loss rate in a loss event which is a random variable; a massive loss density calculating unit configured to calculate a massive loss density of the loss rate density, which corresponds to an loss amount not less than a threshold, based on the transaction amount and the loss rate density; and a risk measure calculating unit configured to calculate operational risk from the massive loss density.

### BRIEF DESCRIPTION OF THE SEVERAL VIEWS OF THE DRAWING

FIG. 1 is a diagram showing an example of a histogram modeling a density function according to the first embodiment of the present invention.

FIG. 2 is a diagram showing an example of a histogram of loss amounts according to the first embodiment of the present invention.

FIG. 3 is a diagram showing another example of a histogram of loss amounts according to the first embodiment of the present invention.

FIG. 4 is a block diagram of an operational risk quantification apparatus concerning the second embodiment of the present invention.

FIG. 5 is a diagram showing a histogram of a loss rate density function according to the second embodiment of the present invention.

FIG. 6 is a block diagram of an operational risk quantification apparatus concerning the third embodiment of the present invention.

FIG. 7 is a block diagram of an operational risk quantification apparatus concerning the fourth embodiment of the present invention.

FIG. 8 is a diagram showing a histogram of a loss rate density function according to the fourth embodiment of the present invention.

FIG. 9 is a block diagram of an operational risk quantification apparatus concerning the fifth embodiment of the present invention.

### DETAILED DESCRIPTION OF THE INVENTION

There will now be described an embodiment of the present invention in conjunction with the accompanying drawings.

There will be explained at first a process for deriving a model for operational risk evaluation with some suppositions according to the first embodiment, and then other embodiments (second to fifth embodiments) concerning concrete quantification using the model. The second and third embodiments can analyze a small loss as well as a massive loss. The fourth and fifth embodiments simplify a process procedure without analyzing a small loss.

### First Embodiment

Considering that the random variable of transaction amount is X (X is a real number greater than or equal to zero), the random variable of loss amount is Y (Y is a real number greater than or equal to zero), the random variable of loss rate is 8 (8 is a real number of greater than or equal to 0 or not more than 1) and the presence or absence of loss: L (0: absence of loss, 1: presence of loss), the loss rate 8 can be represented as the next equation (1).
Θ=Y/X (1)

The transaction amount and the loss amount are integers greater than or equal to zero, but they are assumed to be real numbers to simplify description.

Firstly, P(Y=y, L=l, X=x) establishes the following relation.
P(Y=y, L=l, X=x)=P(Y=y|L=l, X=x)P(L=l|X=x)P(X=x) (2)

It is considered that P(L=l|X=x), which is a probability of a loss event occurs in transaction of the amount of money x is a broadly monotonically decreasing function of the transaction amount x. However, when the transaction amount becomes a large amount of money to some extent, the probability becomes a constant value due to limit of human concentration. Consequently, the following assumption 1 is made.

(Assumption 1): If x≧xth1, P(L=l|X=x)=Pl

In this time,
P(L=1|X=x)=Pl (3),
P(L=0|X=x)=1−Pl (4)

Further, in P(Y=y|L=0, X=x), the following assumption 2 is made.

(Assumption 2): The loss amount when a loss event does not occur is zero. In this time,
P(Y−y|L=0, X=x)=δ(y) (5)

where δ(y) is a delta function of Dirac.

$$P \text{(} Y = y \vert L = 1 , X = x ) = \frac{1}{x} P ( Θ = \frac{y}{x} \vert L = 1 , X = x ) \qquad ( 6 )$$

Θ represents a collection rate, and P(Θ=θ|L=1, X=x) represents a certain probability density that a ratio at which the transaction amount can be collected when an event occurs in transaction of x is θ. Assuming that the collection rate in more than a given amount of money accords to a density function without depending on the transaction amount x, the following assumption 3 is made.

(Assumption of 3): If x≧xth2, P (Θ=θ|L=1, X=x)=P∞(Θ=θ)

In the P(Y=y, L=l) that is a marginal distribution of P(Y=y, L=l, X=x), we concentrate on the case l=1.

$$\begin{matrix}P ( Y = y , L = 1 ) = \int P ( Y = y , L = 1 , X = x ) ⅆ x \\ = \int P ( Y = y \vert L = 1 , X = x ) P ( L = 1 \vert X = x ) P \\ ( X = x ) ⅆ x\end{matrix} \qquad ( 7 )$$

Usually, a loss more than x does not occur in transaction of the transaction amount x. Therefore, the following assumption 4 is made.

(Assumption 4): P(Y=y|L=l, X=x)=0 for {(x,y)|x<y}

In particular, if y≧xth=max(xth1, xth2), taking the assumptions 1 and 3 into consideration, the following equation (8) is established from the equation (7).

$$P ( Y = y , L = 1 ) = {P}_{l} \int \frac{1}{x} {P}_{∞} ( Θ = \frac{y}{x} ) P ( X = x ) ⅆ x \qquad ( 8 )$$

On the other hand,
P(Y=y, L=l)=P(Y=y|L=l)P(L=l) (9)

Therefore, the following equation (10) is established.

$$P \text{(} Y = y \vert L = 1 ) = \frac{{P}_{l}}{P ( L = 1 )} \int \frac{1}{x} {P}_{∞} ( Θ = \frac{y}{x} ) P ( X = x ) ⅆ x \qquad ( 10 )$$

When the number of samples is sufficiently large, the following equation (11) is established by law of large number.

$$P \text{(} Y = y \vert L = 1 ) \approx \frac{{P}_{l}}{P ( L = 1 ) \vert Ω \vert} {\sum }_{i ∈ Ω} \frac{1}{{x}_{i}} {P}_{∞} ( Θ = \frac{y}{{x}_{i}} ) \qquad ( 11 )$$

where Ω is a set of samples. Further, the probability that the loss amount is during an interval from zero to y is expressed by the following equation (12).

$$\begin{matrix}P \text{(} 0 \leq Y < y \vert L = 1 ) \approx \frac{{P}_{l}}{P ( L = 1 )} {\frac{1}{\vert Ω \vert} {\sum }_{i ∈ Ω}}_{} \frac{1}{{x}_{i}} {F}_{∞} ( Θ = \frac{y}{{x}_{i}} ) \\ where \\ {F}_{∞} ( Θ = θ ) = {\int }_{0}^{θ} {P}_{∞} ( Θ = φ ) ⅆ φ \\ Further , & ( 12 ) \\ P ( L = 1 ) = {\int \int }_{( x , y )} ⅆ x ⅆ yP ( Y = y , L = 1 , X = x ) & ( 13 )\end{matrix}$$

Therefore, when the number of samples is sufficiently large, the probability is calculated by the following equation (14).

$$P ( L = 1 ) = \frac{1}{\vert Ω \vert} {\sum }_{i ∈ Ω} {δ}_{{l}_{i} , 1} \qquad ( 14 )$$

δj,k is Kronecker delta. If j and k are equal to each other, δj,k is 1, otherwise it is 0.

Assuming that Ωth={i|xi≧xth}, P1 is expressed by the following equation (15) in assumption 1.

$${P}_{l} = \frac{1}{\vert {Ω}_{th} \vert} {\sum }_{i ∈ {Ω}_{th}} {δ}_{{l}_{i} , 1} \qquad ( 15 )$$

In particular, if Pl=P(L=1), the equation (16) is established.

$$P \text{(} Y = y \vert L = 1 ) \approx \frac{1}{\vert Ω \vert} {\sum }_{i ∈ Ω} \frac{1}{{x}_{i}} {P}_{∞} ( Θ = \frac{y}{{x}_{i}} ) \qquad ( 16 )$$

Distribution of the massive loss amount under the assumptions 1, 2 and 4 can be represented by an equation (11). The quantification of operational risk can be carried out by the following procedure using this condition.

At first a model of P∞(Θ=θ) is made (step S1).

This model is equivalent to a probability density of loss rate in more than a given transaction amount, and corresponds to a process procedure of reading and storing of loss rate density in the embodiment described below. Explaining more concretely, the loss rate density is a probability density when the loss rate (value of 0 to 1) is assumed to be a random variable. For example, if ten events of 100 loss events are the events of 0.5-0.6 (50%-60%) loss rates, the probability that an event of 0.5-0.6 occurs becomes 10/100=0.1. Further, if the probability density is divided by the width of interval, 0.1/(0.6−0.5)=1. This is a loss rate density.

P∞(Θ=θ) may be obtained from the samples belonging to Ωth. A non-parametric technique (a reference document: “Invitation to Smoothing and Non-parametric recursion” J•S•Simonov and Forestry Statistical Association, the entire contents of which are incorporated herein by reference) is a convincing technique. However, a simple example using histogram will be described hereinafter.

P∞(Θ=θ) can take values more than zero in the range of 0≦θ≦1, but it is 0 in a region aside from this range. Consequently, P∞(Θ=θ) is decided in 0≦θ≦1.

Gk (k=1, 2, . . . , k) is defined as follows.

$${R}_{k} = \{ θ \vert \frac{k - 1}{K} \leq θ < \frac{k}{K} \} k = 1 , 2 , … , K - 1 \\ \\ {R}_{k} = \{ θ \vert \frac{k - 1}{K} \leq θ \leq 1 \} k = K$$

Further,
Gₖ={i|θᵢ∈Rₖ and i∈Ωₜₕ} k=1, 2, . . . , K

Then, assuming that Pk is expressed by the following equation.

$${P}_{k} = \frac{\vert {G}_{k} \vert}{\vert {Ω}_{th} \vert}$$

P∞(Θ=θ)=Pk (where θ∈Rk). In this case, an example of P∞(Θ=θ)=Pk is shown in FIG. 1. In this particular example, the distances of thresholds k/K (a k=0, . . . , k) are equal, but the threshold may be changed to any given value. A method of calculating an optimum threshold is described by “Amount of information statistics”, Yoshiyuki Sakamoto et al., Kioritz publication Co., Ltd., the entire contents of which are incorporated herein by reference. “Smoothing Methods in statistics (Springer Series in Statistics) Jeffery S. Simonoff, Springer-Verlag, 1996/07, the entire contents of which are incorporated herein by reference” describes a method of using a frequency polygon and using a kernel function, instead of a histogram.

The probability is calculated by the following equation (step S2).

$$P ( L = 1 ) = \frac{1}{\vert Ω \vert} {\sum }_{i ∈ Ω} {δ}_{{l}_{i} , 1}$$

In this time, assuming that the number of all transactions is N and the number of transactions that an event occurred is N1, P(L=1)=N1/N is calculated. The calculated value corresponds to a rate of loss event read out and stored in an embodiment described below.

The probability P1 is calculated by the following equation (step S3).

$$P = \frac{1}{\vert {Ω}_{th} \vert} {\sum }_{i ∈ {Ω}_{th}} {δ}_{{l}_{i} , 1}$$

A threshold xth is received from the outside, and the samples which the transaction amount is not less than the threshold xth are counted to obtain n. The number of counted samples that an event occurred is assumed to be n1, and P1=n1/n is calculated. The calculated value corresponds to a rate of massive transaction loss event read out and stored in the embodiment described below.

Subsequently, the following equation is calculated (step S4).

$$P ( Y = y \vert L = 1 ) \approx \frac{{P}_{l}}{P ( L = 1 )} \frac{1}{\vert Ω \vert} {\sum }_{i ∈ Ω} \frac{1}{{x}_{i}} {P}_{∞} ( Θ = \frac{y}{{x}_{i}} )$$

Provided, however, that ymax indicates a max of transaction amount, and ymin=xth.

Also, a plurality of representative points are determined in the range of ymin≦y≦ymax. The following equation is established using a digit value M provided from the outside in the first embodiment.

$${y}_{m} = {y}_{min} + \frac{m}{M} ( {y}_{max} - {y}_{min} ) where m = 0 , 1 , … , M$$

A process of the following steps S4-1 to S4-3 is repeated for all ms.

At first, y=ym is set (step S4-1).

Subsequently, the following equation is calculated.

$$\frac{1}{\vert Ω \vert} {\sum }_{i ∈ Ω} \frac{1}{{x}_{i}} {P}_{∞} ( Θ = \frac{y}{{x}_{i}} )$$

θi=y/xi is calculated for all transaction samples, and the following equation is calculated using a function P∞(Θ=θ) obtained in step S1.

$$\frac{1}{{x}_{i}} {P}_{∞} ( Θ = \frac{y}{{x}_{i}} )$$

An average of calculated values of all samples is calculated (step S4-2).

pmmax is calculated using a result of steps S2, S3 and S4-2 according to the following equation (step S4-3).

$${Pm}^{max} = \frac{{P}_{l}}{P ( L = 1 )} \frac{1}{\vert Ω \vert} {\sum }_{i ∈ Ω} \frac{1}{{x}_{i}} {P}_{∞} ( Θ = \frac{y}{{x}_{i}} )$$

In the next step,

P(Y=y|L=1) is represented by a histogram.

$$P ( Y = y \vert L = 1 ) \underline{\underline{def}} {Pm}^{max} in the region$$

$$\frac{{y}_{m - 1} + {y}_{m}}{2} \leq y \leq \frac{{y}_{m} + {y}_{m + 1}}{2} .$$

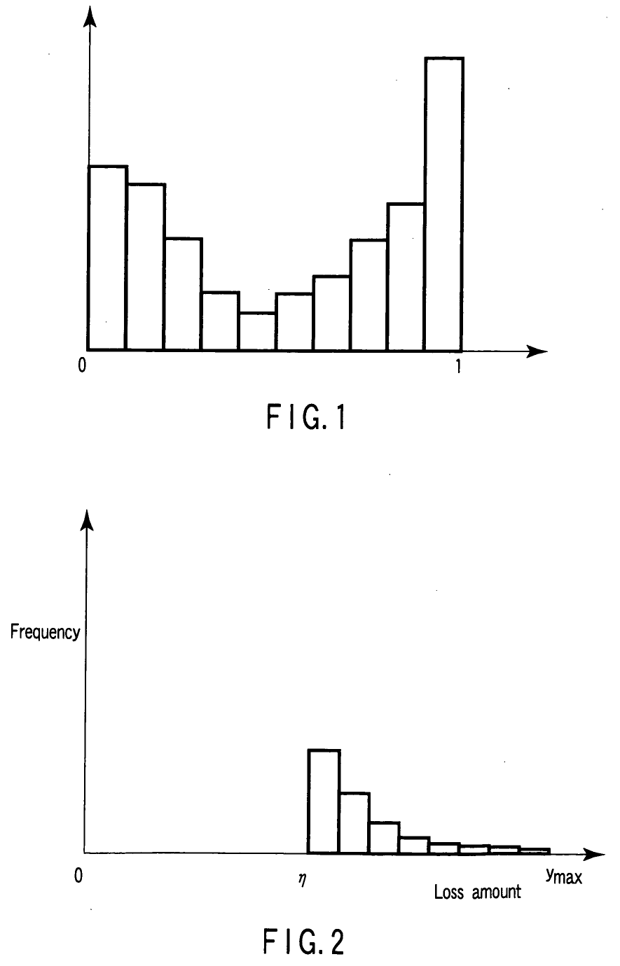

As a result, the histogram shown in FIG. 2 is obtained. η=(y0+y1)/2 (step S5). The obtained histogram corresponds to the massive loss density calculated in the embodiment described below. The probability density when the loss amount is assumed to be a random variable is referred to as “loss density”. In particular, the loss density corresponding to the loss amount not less than the threshold is referred to as “massive loss density”.

Subsequently, a model wherein y is small is made. This model corresponds to reading and storing of the small condition loss density in the embodiment described below.

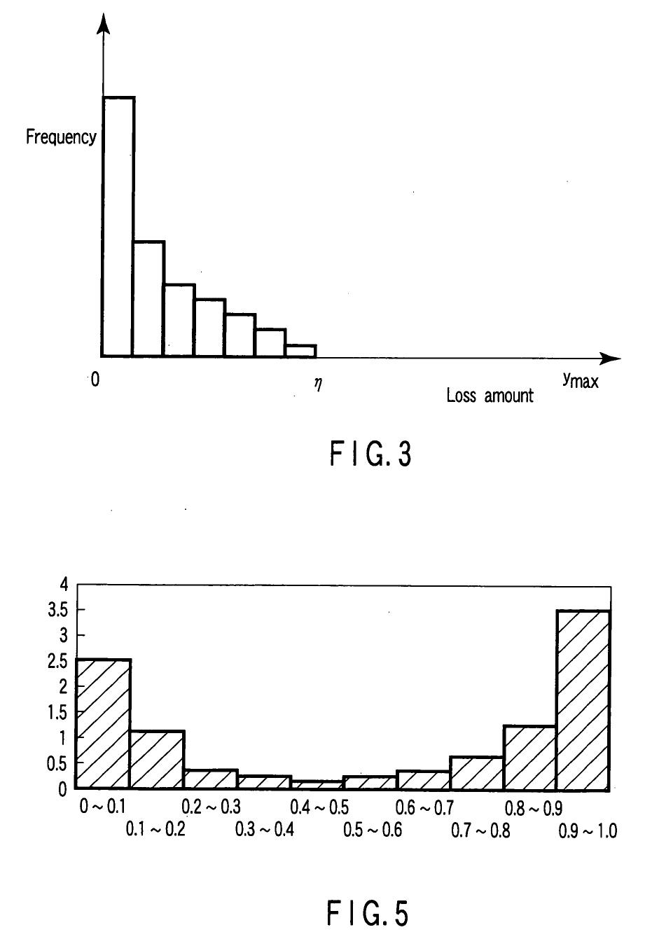

Similarly to step S1, a histogram in a range that y is smaller than ymin is depicted using the histogram similarly to step S1 (FIG. 3).

The samples that an event occurs and the loss amount is smaller than η are collected from all samples. Assuming that the set of collected samples is Ωmin. The following sets obtained by dividing the set of samples into U sample sets are considered.

$${H}_{u} = \{ i \vert \frac{u - 1}{U} η \leq {y}_{i} \leq \frac{u}{U} η and {l}_{i} = 1 \} ( u = 1 , … , U )$$

In this time, assuming that the number of samples that an event occurs and the loss amount y is smaller than η is Nmin and the number of samples belonging to Hu is Numin, the following equation is calculated.

$${p}_{u}^{min} = \frac{1}{\frac{η}{U}} \frac{{N}_{u}^{min}}{{N}^{min}}$$

Subsequently, distribution of P(Y=y|L=1) is obtained (step S7). This corresponds to calculation of a loss density in the embodiment described below.

The pumin obtained in step S6 indicates a distribution function with a condition that an event occurs and the loss amount y is smaller than η, so that it is necessary for calculation of P(Y=y|L=1) to multiply a probability q that an event occurs, and the loss amount y is smaller than η. This can be calculated as follows.

$$q = 1 - {\sum }_{m = 1}^{M} {p}_{m}$$

$$Therefore , \\ If \frac{u - 1}{U} η \leq y \leq \frac{u}{U} η , P \text{(} Y = y \vert L = 1 ) = {qp}_{u}^{min} \\ If \frac{{y}_{m - 1} + {y}_{m}}{2} \leq y \leq \frac{{y}_{m} + {y}_{m + 1}}{2} , P ( Y = y \vert L = 1 ) = {p}_{m}^{max}$$

At the last, quantification of operational risk is done (step S8). A technique of quantification will be explained in another embodiment, but can use a well-known technique.

According to the first embodiment described above, it is possible to derive a model for evaluating the operational risk under four assumptions as described above, and quantify the operational risk in step S8, using the model. A well-known technique can be used for quantification of the operational risk in step S8.

### Second Embodiment

The second embodiment of the present invention makes it possible to analyze a small loss as well as a massive loss.

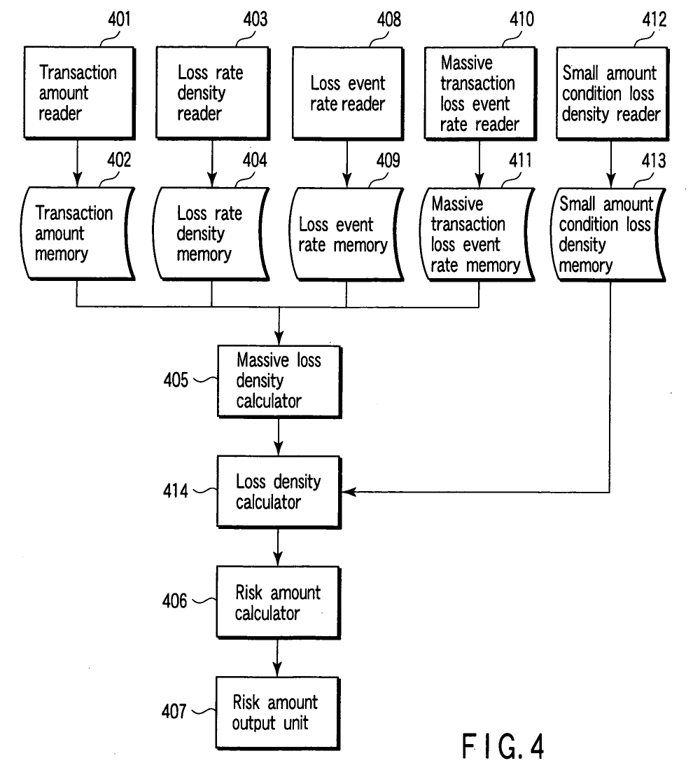

FIG. 4 is a block diagram of operational risk quantification apparatus concerning the second embodiment of the present invention. This apparatus can be realized using a computer.

A program of realizing a function concerning the embodiment of the present invention is stored by a program memory (not shown). The program memory comprises an external memory such as a magnetic disk device or an optical disk device.

The program is read into a main memory such as a random access memory (RAM) under control of a CPU, and executed by the CPU. As a result, it is possible to make a computer function as the operational risk quantification apparatus concerning the embodiment of the present invention. In the operational risk quantification apparatus is introduced an operating system, which manages various computer resources and provides a file system, a network communication function and a graphical user interface (GUI).

The operational risk quantification apparatus concerning the third to fifth embodiments described below can be realized using a computer. At first, a transaction amount reader 401 reads a transaction amount in each transaction of a bank for the past one year. A transaction for a specified time period (for example, from Apr. 1, 2003 to Mar. 31, 2004) is extracted from data of a format such as a Table 1 and stored in a transaction amount memory 402.

TABLE 1

| Record | Transaction | Transaction time | Branch |
|---|---|---|---|
| No. | amount | (yyyy/mm/dd/hh/mm) | No. |
| 1 | 200,000 | 2004/02/24/10/22 | 1 |
| 2 | 10,000 | 2004/02/24/10/23 | 1 |
| 3 | 30,000 | 2004/02/24/10/25 | 12 |
| . . . | . . . | . . . | . . . |

The transaction amount memory 402 uses the main memory, but when the amount of data is large, an external storage is used. The set of transaction amounts is written as {xi|i∈Ω}. Ω indicates a set of record numbers of transactions included during a designated period of time, and xi indicates a transaction amount of a transaction of a record number i.

A loss rate density function P∞(Θ=θ) is read by a loss rate density reader 403. The loss rate density function is defined in a range of more than or equal to 0 and not more than 1, and has an output value more than or equal to 0. When the loss rate density function during an interval from 0 to 1 is integrated, the result becomes 1.

In the present embodiment, the histogram of the loss rate density function shown in FIG. 5 is considered, but the data is stored in a loss rate density memory 404 in a format as shown in a Table 2, concretely.

TABLE 2

| | | | | | | | | | | |
|---|---|---|---|---|---|---|---|---|---|---|
| Input value | 0-0.1 | 0.1-0.2 | 0.2-0.3 | 0.3-0.4 | 0.4-0.5 | 0.5-0.6 | 0.6-0.7 | 0.7-0.8 | 0.8-0.9 | 0.9-1.0 |
| Output value | 2.5 | 1.1 | 0.3 | 0.2 | 0.1 | 0.2 | 0.3 | 0.6 | 1.2 | 3.5 |

In the following embodiments, the description “X to Y” is assumed to be represent not less than X and less than Y. Only when Y=1, the above description is assumed to be mean not less than X and not more than Y. If a value of 0.21 is received, a value of 0.3 is returned referring to a column of not less than 0.2 and less than 0.3 in this Table 2. Similarly, when a value of 0.2 is input, a value of 0.3 is output. When a value of 0.3 is input, a value of 0.2 is output. It is assumed that a value of 3.5 is output when in particular a value of 1.0 is input.

A loss event rate reader 408 reads a loss event rate P(L=1) with respect to all transactions and stores it to a loss event rate memory 409. The loss event rate may be calculated from an operation quality evaluation model including an event generation model based on a random number.

A massive transaction loss event rate reader 410 reads a massive transaction loss event rate (a loss event rate with respect to a transaction of not less than one million yen in the present embodiment) Pl, and stores it in a massive transaction loss event rate memory 411.

A small amount condition loss density reader 412 reads a loss density with a condition that a loss of less than one million yen occurred, and stores it in a small amount condition loss density memory 413. The loss density is recorded in a form shown in a Table 3.

TABLE 3

| | | | | | | |
|---|---|---|---|---|---|---|
| Loss amount | 0-10 | 10-100 | 100-1000 | 1000-10000 | 10000-100000 | 100000-1000000 |
| Occurrence provability | 0.07 | 0.001667 | 0.0001 | 0.000004 | 1.78E−07 | 8.88889E−09 |

The loss distribution is 1 when calculating a sum from 0 yen to 999,999 yen (probability of the loss amount of 0 yen+probability of the loss amount of 1 yen+ . . . probability of the loss amount of 999,999 yen=1).

The massive loss density calculator 405 receives a transaction amount {xi|i∈Ω} from the transaction amount memory 402, and information of a loss density function P∞(Θ=θ) from the loss rate density memory 404, a loss event rate P(L=1) from loss outage memory 409, and a massive transaction loss event rate Pl from the massive transaction loss event rate memory 411, and calculates the following equation.

$$P \text{(} Y = y \vert L = 1 ) \approx \frac{{P}_{1}}{P ( L = 1 )} \frac{1}{\vert Ω \vert} {\sum }_{i ∈ Ω} \frac{1}{{x}_{i}} {P}_{∞} ( Θ = \frac{y}{{x}_{i}} )$$

This calculation is executed repeatedly as changing y. A Table 4 is an example gathering calculation results obtained by executing this calculation every million yen.

TABLE 4

| Loss amount | Provability |
|---|---|
| (million yen) | (× 0.000001) |
| 1-2 | 0.00151 |
| 2-3 | 0.000657266 |
| 3-4 | 0.000404047 |
| 4-5 | 0.000286092 |
| 5-6 | 0.000218883 |
| 6-7 | 0.000175871 |
| 7-8 | 0.00014617 |
| 8-9 | 0.000124529 |
| 9-10 | 0.000108115 |
| 11-12 | 9.52746E-05 |
| 9,995-9,996 | 2.39463E-08 |
| 9,996-9,997 | 2.39434E-08 |
| 9,997-9,998 | 2.39405E-08 |
| 9,998-9,999 | 2.39376E-08 |
| 9,999-10,000 | 2.39348E-08 |
| 10,000- | |

The calculation may be executed as changing y every 1 yen. However, in that case, an amount of calculation becomes enormous. Therefore, the calculation is assumed to be executed every million yen in the present embodiment (for example, a digit value in the case of y=1.5 million yen is written in ‘1-2’ columns).

The loss density calculator 414 calculates a loss density function from a massive loss density calculated with the massive loss density calculator 405 and a small amount condition loss density stored in the small amount condition loss density memory 413. Concretely, the loss density more than one million yen is assumed to be a massive loss density calculated with the massive loss density calculator 405. The probability that the loss more than one million yen occurs can be calculated based on the massive loss density calculated with the massive loss density calculator 405 according to the following equation.
η=∫₁₀₀₀₀₀₀^{∞}P(Y=y|L=l)dy

The loss density of less than one million yen is assumed to be a value obtained by multiplying a small condition loss density stored in the loss density memory 413 by 1−η. If η=0.01, a loss density of less than one million yen as shown in a Table 5 is obtained.

TABLE 5

| | | | | | | |
|---|---|---|---|---|---|---|
| Loss amount | 0-10 | 10-100 | 100-1,000 | 1,000-10,000 | 10,000-100,000 | 100,000-1,000,000 |
| Occurrence provability | 0.0693 | 0.00165 | 0.000099 | 0.96E-06 | 1.7622E-07 | 8.8E-09 |

If this is combined with the massive density not less than one million yen, a Table 6 is obtained.

TABLE 6

| | Occurrence |
|---|---|
| Loss amount | provability |
| 0-10 | 0.0693 |
| 10-100 | 0.00165033 |
| 100-1,000 | 0.000099 |
| 1,000-10,000 | 0.00000396 |
| 10,000-100,000 | 1.7622E-07 |
| 100,000-1,000,000 | 8.8E-09 |
| 1,000,000-2,000,000 | 0.00151 |
| 2,000,000-3,000,000 | 0.000657266 |
| 3,000,000-4,000,000 | 0.000404047 |
| 4,000,000-5,000,000 | 0.000286092 |
| 5,000,000-6,000,000 | 0.000218883 |
| 6,000,000-7,000,000 | 0.000175871 |
| 7,000,000-8,000,000 | 0.00014617 |
| 8,000,000-9,000,000 | 0.000124529 |
| 9,000,000-10,000,000 | 0.000108115 |
| 11,000,000-12,000,000 | 9.52746E-05 |
| . . . | . . . |
| 9,995,000,000-9,996,000,000 | 2.39463E-08 |
| 9,996,000,000-9,997,000,000 | 2.39434E-08 |
| 9,997,000,000-9,998,000,000 | 2.39405E-08 |
| 9,998,000,000-9,999,000,000 | 2.39376E-08 |
| 9,999,000,000-10,000,000,000 | 2.39348E-08 |
| 10,000,000,000- | 0 |

Further, a Table 7 is acquired as a loss cumulative provability.

TABLE 7

| | Cumulative |
|---|---|
| Loss amount | provability |
| 0 | 0.0693 |
| 1 | 0.1386 |
| 2 | 0.2772 |
| 3 | 0.2772 |
| 4 | 0.3465 |
| 5 | 0.4158 |
| 6 | 0.4851 |
| 7 | 0.5544 |
| 8 | 0.6237 |
| 9 | 0.693 |
| 10 | 0.69465033 |
| 11 | 0.69630066 |
| 12 | 0.69795099 |
| 9,999,999,998 | 0.999999952 |
| 9,999,999,999 | 0.999999976 |
| 10,000,000,000 | 1 |

The risk calculator 406 calculates a risk (for example VaR) and an expected value of the loss amount as operational risk using the loss event rate stored in the loss event rate memory 409 and the loss cumulative provability calculated with the loss density calculator 414. VaR is explained in detail by a reference document, for example, “a value-at-risk on quantification of a finance risk”, ed. Masaaki Kijima).

The operational risk calculated by the risk measure calculator 406 is called a risk measure for a future transaction. The loss amount is called “risk” to become very large contrary to all expectations. The operational risk can be obtained as a percentile point of a given upper part in the amount-of-loss total density function wherein a horizontal axis indicates an amount-of-loss total during a given period and a vertical axis indicates a provability density with respect to each amount-of-loss.

Alternatively, the operational risk may be obtained as an average of a total of the amounts of losses more than a percentile point of the given upper part in the amount-of-loss total density function wherein a horizontal axis indicates an amount-of-loss total during a given period and a vertical axis indicates a provability density with respect to each amount-of-loss.

An example of a process procedure for a risk measure calculation will be described more concretely. At first, assuming that λ=P(L=1) and Poisson distribution of the parameter λ is considered.

$${p}_{k} = {ⅇ}^{- λ} \frac{{λ}^{k}}{k !}$$

An example of pk in case of λ=10 is shown in a Table 8.

TABLE 8

| The number | Provability | |
|---|---|---|
| of events | distribution | Cumulative |
| (k) | (Pk) | provability |
| 0 | 4.53999E-05 | 4.53999E-05 |
| 1 | 0.000453999 | 0.000499399 |
| 2 | 0.002269996 | 0.002769396 |
| 3 | 0.007566655 | 0.010336051 |
| 4 | 0.018916637 | 0.029252688 |
| 5 | 0.037833275 | 0.067085963 |
| 6 | 0.063055458 | 0.130141421 |
| 7 | 0.090079226 | 0.220220647 |
| 8 | 0.112599032 | 0.332819679 |
| 9 | 0.125110036 | 0.457929714 |
| 10 | 0.125110036 | 0.58303975 |
| 11 | 0.113736396 | 0.696776146 |
| 12 | 0.09478033 | 0.791556476 |
| 13 | 0.072907946 | 0.864464423 |
| 14 | 0.052077104 | 0.916541527 |
| 15 | 0.03471807 | 0.951259597 |
| 16 | 0.021698794 | 0.97295839 |
| 17 | 0.012763996 | 0.985722386 |
| 18 | 0.007091109 | 0.992813495 |
| 19 | 0.003732163 | 0.996545658 |
| 20 | 0.001866081 | 0.998411739 |
| 21 | 0.00088861 | 0.999300349 |
| 22 | 0.000403914 | 0.999704263 |
| 23 | 0.000175615 | 0.999879878 |
| 24 | 7.31728E-05 | 0.999953051 |
| 25 | 2.92691E-05 | 0.99998232 |
| 26 | 1.12573E-05 | 0.999993577 |
| 27 | 4.16939E-06 | 0.999997746 |
| 28 | 1.48907E-06 | 0.999999236 |
| 29 | 5.13472E-07 | 0.999999749 |
| 30 | 1.71157E-07 | 0.99999992 |
| Not less | 7.98379E-08 | 1 |
| than 31 | | |

The accumulative provability of the Table 8 is expressed by the following equation.

$${\sum }_{i = 0}^{k} {p}_{i}$$

For example, if k=2, it means a provability that the number of events is not more than two. Such a Table is prepared beforehand according to the parameter λ.

A random number generator generates real numbers from 0 to 1 at random. When the random number is x, the number of events is determined based on the Table 8. The Table 8 shows that if the x is less than 4.53999E-05, the event is 0, if it is less than 0.000499399 and not less than 4.53999E-05, the event is 1, . . . For example, if x=0.8, the accumulative provability is not less than 0.791556476 and less than 0.864464423. Thus, the number of events is assumed to be 13.

Subsequently, the loss amounts concerning the events of losses, respectively, are set. The uniform random numbers are generated by the number of events, and the loss amount is settled by the Table 7. For example, if the random number is 0.5, the accumulative provability is not less than 0.4851 and less than 0.5544. Therefore, the loss amount is 7 yen. If 13 events occur, the loss amount is determined by a similar process for each event.

The amounts of losses for the number of events are added up. For example, the amounts of losses of 13 events are added up to obtain 15,568.

The above process is repeated the designated number of times (N times). The risk measure output unit 407 sorts the N amounts of losses in the descending order, and outputs a value in the top 0.1% point as VaR of 99.9% level. The average of the N amounts of losses is calculated, and output as the expected loss amount. If N=one million times, the top 0.1% corresponds to the loss amount of the top 1000-th. The calculated result in the top 0.1% of the loss amounts are extracted, and the expected value of the loss amounts of the extracted samples is calculated, and this is output as CVaR (conditional value at risk).

### Third Embodiment

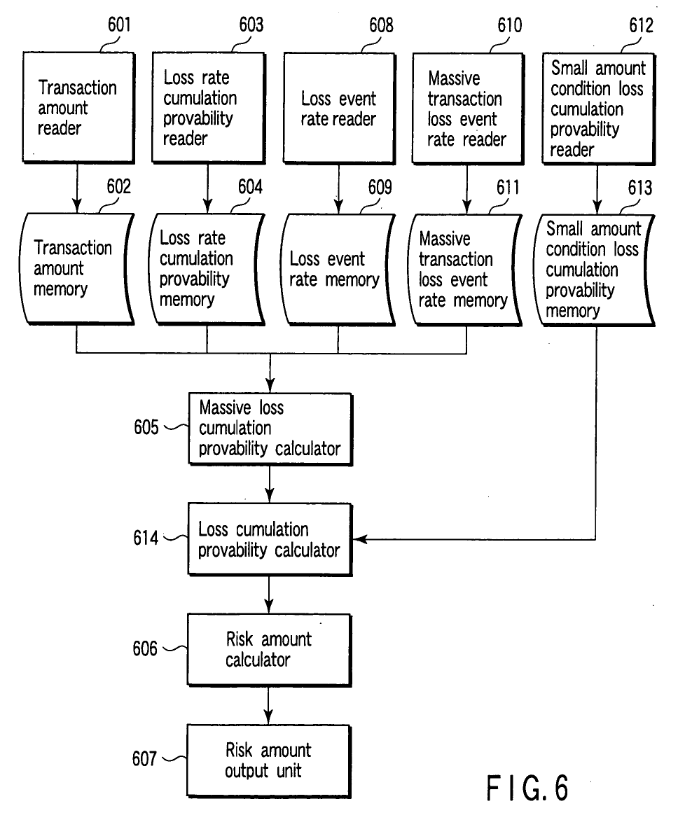

FIG. 6 is a block diagram of operational risk quantification apparatus concerning the third embodiment of the present invention. The third embodiment differs from the second embodiment in a point to read accumulative provability of a loss rather than reading probability density of a loss. In other words, the loss rate cumulative provability reader 603 and small condition loss cumulative provability reader 612 in FIG. 6 differ from the second embodiment (FIG. 4). As a result, the process procedure of the massive loss accumulative provability calculator 605 and loss accumulative provability calculator 614 differs from the second embodiment.

The transaction amount reader 601 reads a transaction amount in each transaction of a bank for the past one year. Transactions during a designated period of time (for example, from Apr. 1, 2003 to Mar. 31, 2004) are extracted from data of a format as shown in the Table 1, and accumulated into a transaction amount memory 602.

The transaction amount memory 602 uses the main memory, but when an amount of data is large, an external memory is used. The set of transaction amounts is written as {xi|i∈Ω}. Ω is a set of record numbers of transactions included during a designated period of time, and xi is a transaction amount of a transaction of a record number i.

The loss rate accumulative provability reader 603 reads a loss rate accumulative provability, namely the following equation.
F_{∞}(Θ=θ)=∫₀^{θ}P_{∞}(Θ=ψ)d

The loss rate density function is defined in a range of more than 0 and not more than 1, and has an output value more than 0. In the present embodiment, the loss rate accumulative provability function memory 604 stores data in a format as shown in a Table 9.

TABLE 9

| | | | | | | | | | | |
|---|---|---|---|---|---|---|---|---|---|---|
| Loss rate | 0.1 | 0.2 | 0.3 | 0.4 | 0.5 | 0.6 | 0.7 | 0.8 | 0.9 | 1 |
| Cumulative occurrence provability | 0.25 | 0.36 | 0.39 | 0.41 | 0.42 | 0.44 | 0.47 | 0.53 | 0.65 | 1 |

The loss event rate reader 608 reads the loss event rate P(L=1) with respect to all transactions, and stores it in the loss event rate memory 609. The massive transaction loss event rate reader 610 reads a massive transaction loss event rate (a loss event rate to a transaction of not less than one million yen in the present embodiment) Pl, and stores it in the massive transaction loss event memory 611. The small condition loss cumulative provability reader 612 reads the loss density of less than one million yen, and stores it in the small amount condition loss cumulative provability memory 613. The loss cumulative provability is recorded in form as shown in a Table 10.

TABLE 10

| | | | | | | |
|---|---|---|---|---|---|---|
| Loss amount | 10 | 100 | 1,000 | 10,000 | 100,000 | 1,000,000 |
| Cumulative | 0.7 | 0.85003 | 0.94003 | 0.97603 | 0.99205 | 1 |
| occurrence | | | | | | |
| provability | | | | | | |

The massive loss accumulative provability calculator 605 receives a transaction amount {xi|i∈Ω} from the transaction amount memory 602, information of a loss rate cumulative provability function F∞(Θ=θ) from the loss rate cumulative provability function memory 604, a loss event rate P(L=1) from the loss event rate memory 609, and a massive transaction loss event rate P0l from the massive transaction loss event memory 611, and calculates the following equation.

$$P \text{(} 0 \leq Y < y \vert L = 1 ) \approx \frac{{P}_{l}}{P ( L = 1 )} \frac{1}{\vert Ω \vert} {\sum }_{i ∈ Ω} \frac{1}{{x}_{i}} {F}_{∞} ( Θ = \frac{y}{{x}_{i}} )$$

This calculation is executed repeatedly as changing y. A Table 11 is an example gathering calculation results obtained by executing this calculation every million yen.

TABLE 11

| Loss amount | Loss cumulative |
|---|---|
| (million yen) | provability |
| 1 | 0.99 |
| 2 | 0.99151 |
| 3 | 0.992167266 |
| 4 | 0.992571312 |
| 5 | 0.992857404 |
| 6 | 0.993076287 |
| 7 | 0.993252159 |
| 8 | 0.993398329 |
| 9 | 0.993522858 |
| 10 | 0.993630973 |
| 9,995 | 0.99999988 |
| 9,996 | 0.999999904 |
| 9,997 | 0.999999928 |
| 9,998 | 0.999999952 |
| 9,999 | 0.999999976 |
| not less than | |
| 10,000 | 1 |

The calculation may be executed as changing y every 1 yen. However, in that case, an amount of calculation becomes enormous. Therefore, the calculation is assumed to be executed every million yen and interpolate a value therebetween linearly in the present embodiment (of course, it may be approximated to a curve such as curve of the second order).

The loss cumulative provability calculator 614 calculates a loss cumulative provability from the massive loss cumulative provability calculated with the massive loss cumulative provability calculator 605 and the small amount condition loss accumulative provability stored in the small amount condition loss cumulative provability memory 613. Concretely, the loss cumulative provability not less than one million yen is assumed to be the massive loss cumulative provability calculated with the massive loss accumulative provability calculator 605. The probability that a loss of less than one million yen can be calculated according to the following equation using the massive loss cumulative provability calculated with the massive accumulative provability calculator 605.
1−η=P(0≦Y<1000000|L=1)

The loss cumulative provability of less than one million yen is assumed to be a value obtained by multiplying the small amount condition loss density stored in the small condition loss accumulative provability memory 613 by 1−η.

If η=0.01, the loss cumulative provability of less than one million yen as shown in a Table 12 is obtained.

TABLE 12

| | | | | | | |
|---|---|---|---|---|---|---|
| Loss amount | 10 | 100 | 1,000 | 10,000 | 100,000 | 1,000,000 |
| Cumulative | 0.693 | 0.84153 | 0.93063 | 0.9662697 | 0.9821295 | 0.99 |
| occurrence | | | | | | |
| provability | | | | | | |

A Table 13 is made by the loss accumulative provability of less than one million yen and that of not less than one million yen.

TABLE 13

| | Cumulative |
|---|---|
| | occurrence |
| Loss amount | provability |
| 10 | 0.693 |
| 100 | 0.8415297 |
| 1,000 | 0.9306297 |
| 10,000 | 0.9662697 |
| 100,000 | 0.9821295 |
| 1,000,000 | 0.99 |
| 2,000,000 | 0.99151 |
| 3,000,000 | 0.992167266 |
| 4,000,000 | 0.992571312 |
| 5,000,000 | 0.992857404 |
| 6,000,000 | 0.993076287 |
| 7,000,000 | 0.993252159 |
| 8,000,000 | 0.993398329 |
| 9,000,000 | 0.993522858 |
| 10,000,000 | 0.993630973 |
| 9,995,000,000 | 0.99999988 |
| 9,996,000,000 | 0.999999904 |
| 9,997,000,000 | 0.999999928 |
| 9,998,000,000 | 0.999999952 |
| 9,999,000,000 | 0.999999976 |
| 10,000,000,000 | 1 |

The risk measure calculator 606 calculates a risk (for example VaR) and the expected value of the loss amount using the loss event rate stored in the loss event rate memory 609 and the loss cumulative provability calculated with the loss cumulative provability calculator 614. An example of a process procedure for the risk measure calculation is as follows.

At first, assuming that λ=P(L=1) and Poisson distribution of the parameter λ is considered.

$${p}_{k} = {ⅇ}^{- λ} \frac{{λ}^{k}}{k !}$$

An example of pk in case of λ=10 is shown in the Table 8. The cumulative probability of the Table 8 is represented by the following equation.

$${\sum }_{i = 0}^{k} {p}_{i}$$

For example, if k=2, it means a provability that the number of events is not more than two.

Such a Table is prepared beforehand according to the parameter λ. A random number generator generates real numbers from 0 to 1 at random. When a random number is x, the number of events is determined based on the Table 8. The Table 8 shows that if x is less than 4.53999E-05, the event is 0, if it is less than 0.000499399 and not less than 4.53999E-05, the event is 1, . . . For example, if x=0.8, the accumulative provability is not less than 0.791556476 and less than 0.864464423. Thus, the number of events is assumed to be 13.

Subsequently, the loss amounts concerning the events of losses, respectively, are set. A uniform random number is generated every number of events, and the loss amount is settled by a Table 13. For example, if the random number is 0.5, the accumulative provability is not more than 0.693. Therefore, the loss amount is between 0 yen and 7 yen. This situation can be understood. When interpolating in a linear line between (0,0)→(10,0.693), the following equation is calculated.

$$\frac{0.5}{0.693} \times 10 \approx 7$$

In this case, the loss amount is assumed to be 7 yen. If 13 events occur, the loss amount is determined by a similar process for each event. The amounts of losses for the number of events are added up. For example, the amounts of losses of 13 events are added up to obtain 15,568.

The above process is repeated the designated number of times (N times). The risk measure output unit 607 sorts the N amounts of losses in the descending order, and outputs a value in the top 0.1% point as VaR of 99.9% level. The average of the N amounts of losses is calculated, and output as the expected loss amount. If N=one million times, the top 0.1% corresponds to the loss amount of the top 1000-th. The calculated result in the top 0.1% of the loss amounts are extracted, and the expected value of the loss amounts of the extracted samples is calculated, and this is output as CVaR.

### Fourth Embodiment

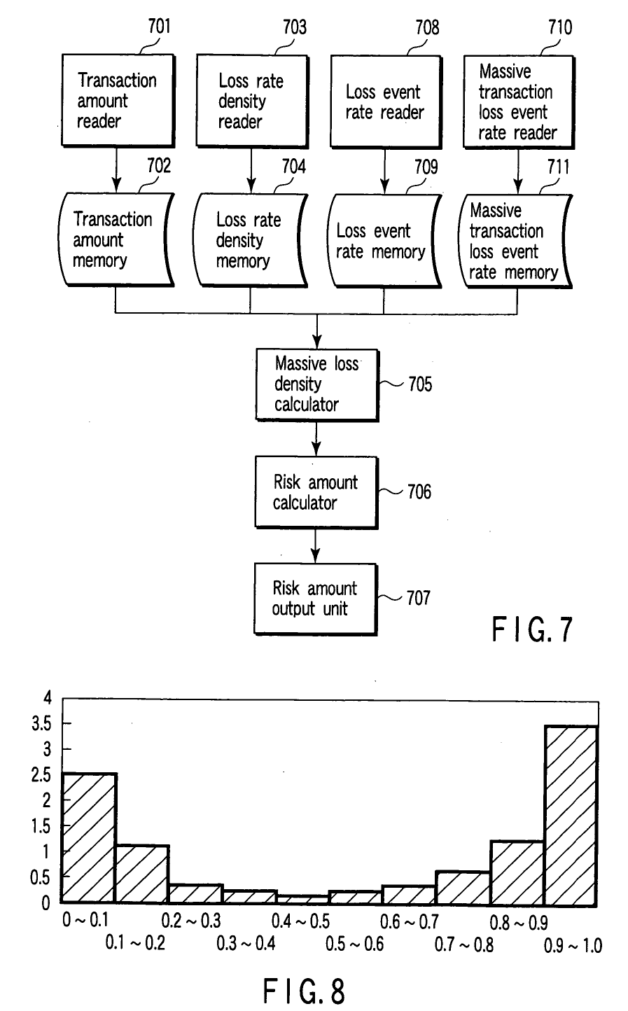

The fourth embodiment simplifies a process procedure without analyzing a small loss. FIG. 7 is a block diagram of operational risk quantification apparatus concerning the fourth embodiment of the present invention. A transaction amount reader 701 reads a transaction amount in each transaction of a bank for the past one year. The transaction amount reader 701 extracts a transaction of a designated period of time (for example, from Apr. 1, 2003 to Mar. 31, 2004) from data of a format as shown in the Table 1, and accumulate it into the transaction amount memory 702.

A transaction amount memory 702 uses the main memory, but when an amount of data is large, an external memory is used. A set of transaction amounts is written as {xi|i∈Ω}. Ω is a set of record numbers of transactions included during a designated period of time, and xi is a transaction amount of a transaction of a record number i.

A loss rate density reader 703 reads a loss rate density function P∞(Θ=θ).

The loss rate density function is defined in a range of not less than 0 and not more than 1, and has an output value not less than 0. When the loss rate density function during an interval from 0 to 1 is integrated, the result is 1. In the fourth embodiment, the histogram of the loss rate density function shown in FIG. 8 is considered, but the data is stored in a loss rate density storage 704 in a format as shown in the Table 2, concretely.

A loss event rate reader 708 reads the loss event rate P(L=1) with respect to all transactions, and stores it in a loss event rate memory 709. A massive transaction loss event rate reader 710 reads a massive transaction loss event rate (a loss event rate to a transaction of not less than one million yen in the fourth embodiment) Pl and stores in the massive transaction loss event memory 711.

A massive loss density calculator 705 receives a transaction amount {xi|i∈Ω} from the transaction amount memory 702, and information of a loss density function P∞(Θ=θ) from the loss rate density memory 704, a loss event rate P(L=1) from a loss outage memory 709, and a massive transaction loss event rate Pl from the massive transaction loss event rate memory 711, and calculates the following equation.

$$P \text{(} Y = y \vert L = 1 ) \approx \frac{{P}_{l}}{P ( L = 1 )} \frac{1}{\vert Ω \vert} {\sum }_{i ∈ Ω} \frac{1}{{x}_{i}} {P}_{∞} ( Θ = \frac{y}{{x}_{i}} )$$

This calculation is executed repeatedly as changing y. The Table 4 is an example gathering calculation results obtained by executing this calculation every million yen.

The calculation may be executed as changing y every 1 yen. However, in that case, an amount of calculation becomes enormous. Therefore, the calculation is assumed to be executed every million yen in the present embodiment (for example, a digit value in the case of y=1.5 million yen is written in ‘1-2’ columns). Further, the Table 11 is made based on the Table 4.

According to the Table 4, because the loss generate probability of more than 10,000 is 0, the accumulative provability of more than 10,000 of the Table 11 is 1 (=1−0). Further, because the loss generate probability of 9,999-10,000 is 2.39348E-08 in the Table 4, the accumulative provability to 9,999 becomes 0.999999976 (=1−2.39348 E-08). If the similar procedure is repeated, the Table 11 can be completed.

The risk volume calculator 706 calculates a risk (for example VaR) and an expected value of the loss amount using the loss event rate stored in the loss event rate memory 709 and the calculated loss accumulative provability.

An example of a process procedure for a risk measure calculation is as follows.

At first, assuming that λ=an expected value of the number of event occurrences, and Poisson distribution of the parameter λ is considered.

$${p}_{k} = {ⅇ}^{- λ} \frac{{λ}^{k}}{k !}$$

An example of pk in case of λ=10 is shown in the Table 8. The accumulative provability of the Table 8 is expressed by the following equation.

$${\sum }_{i = 0}^{k} {p}_{i}$$

For example, if k=2, this means provability that the number of events is not more than two. Such a Table is prepared according to the parameter λ beforehand.

A uniform random number generator generates real numbers from 0 to 1 at random. When a value of a random number is assumed to be x, the number of events is determined based on the Table 8. In the Table 8, if the accumulative provability is not more than 4.53999E-05, the number of events is 0, it is not more than 0.000499399 and more than 4.53999E-05, the number of events is 1, . . . For example, if x=0.8, the accumulative provability is not less than 0.791556476 and less than 0.864464423. In this time, the number of events is assumed to be 13.

The amounts of losses concerning the loss events, respectively, are set. The uniform random numbers are generated by the number of events, and the loss amount is settled using the Table 11. Because only the massive loss is considered as an object in the fourth embodiment, the accumulative provability of less than one million yen is not settled by the Table 11. However, It can be speculated from the Table 11 that the probability that the loss is less than million yen is 99%. Accordingly, if the value obtained by generating the uniform random number between 0-1 is not more than 0.99, the loss amount is not more than one million yen. In this case, an amount of money is set at a value u of not less than 0 and not more than one million yen. Assume u=1000 yen herein.

Concretely, if the value of the random number is 0.5, the cumulative provability is less than 0.99, so that the loss amount is 1000 yen. If the value of the random number is 0.9930, the loss amount is between five million yen and six million yen. The loss amount is assumed to be six million yen supposing the worst case herein. If 13 events occur, the loss amount is settled by doing a similar process for each event.

The amounts of losses corresponding to the number of events are added up. For example, when the amounts of losses of 13 events are added up, for example, 15,568,000 yen are obtained.

The above process is repeated by designated times (N times). A risk measure output unit 707 sorts the N amounts of losses in the descending order, and outputs the value in the top 0.1% point as VaR of 99.9% level. The risk measure output unit 707 calculates an average of N amounts of losses and outputs it as an expected loss amount. For example, if N=one million times, the top 0.1% corresponds to the loss amount in the top 1000th. The calculated result of the loss amounts in the top 0.1% are extracted, and the expected value of the loss amounts of the extracted samples is calculated to be output as CVaR.

### Fifth Embodiment

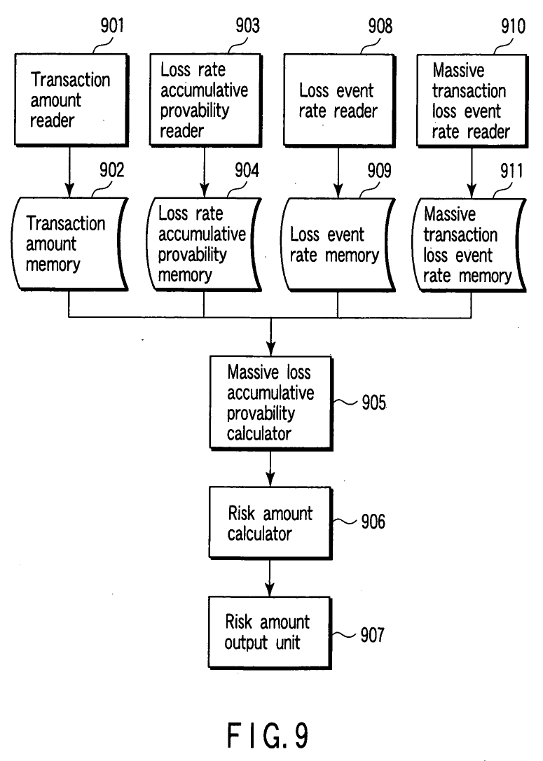

FIG. 9 is a block diagram of an operational risk quantification apparatus concerning the fifth embodiment of the present invention. The fifth embodiment simplifies a process procedure without analyzing a small loss amount similarly to the fourth embodiment. The fifth embodiment differs from the fourth embodiment in a point to read the accumulative provability rather than reading the probability density.

In other words, a loss rate accumulative provability reader 903 of FIG. 9 differs from that of the fourth embodiment (FIG. 6). As a result, the process done by a massive loss accumulative provability calculator 905 differs from that of the fourth embodiment.

At first, a transaction amount reader 901 reads a transaction amount in each transaction of a bank for the past one year. Transactions during a designated period of time (for example, from Apr. 1, 2003 to Mar. 31, 2004) are extracted from data of a format as shown in the Table 1, and accumulated in a transaction amount memory 902. The transaction amount memory 902 uses a main memory, but when the amount of data is large, an external memory is used.

The collection of transaction amount is written as {xi|i∈Ω}. Ω is a set of record numbers of transactions included during a designated period of time, and xi is a transaction amount of a transaction of a record number i. The loss rate accumulative provability reader 903 reads a loss rate accumulative provability, namely the following equation.
F_{∞}(Θ=θ)=∫₀^{∞}P_{∞}(Θ=ψ)d

The loss rate density function is defined in a range of more than or equal to 0 and not more than 1, and has an output value more than or equal to and not more than 0. In the fifth embodiment, the loss rate cumulative provability function memory 904 stores data in a format as shown in the Table 9. The loss event rate reader 908 reads the loss event rate P(L=1) with respect to all transactions, and stores it in a loss event rate memory 909.

A massive transaction loss event rate reader 910 reads a massive transaction loss event rate (a loss event rate to a transaction of not less than one million yen in the fifth embodiment) Pl and stores it in a massive transaction loss event memory 911. The massive loss density calculator 905 receives a transaction amount {xi|i∈Ω} from the transaction amount memory 902, and information of a loss density function P∞(Θ=θ) from the loss rate density memory 904, a loss event rate P(L=1) from the loss outage memory 909, and a massive transaction loss event rate Pl from the massive transaction loss event rate memory 911, and calculates the following equation,

$$P \text{(} 0 \leq Y < y \vert L = 1 ) \approx \frac{{P}_{l}}{P ( L = 1 )} \frac{1}{\vert Ω \vert} {\sum }_{i ∈ Ω} \frac{1}{{x}_{i}} {F}_{∞} ( Θ = \frac{y}{{x}_{i}} )$$

This calculation is executed repeatedly as changing y. The Table 11 is an example gathering calculation results obtained by executing this calculation every one million yen. The calculation may be executed as changing y every 1 yen. However, in that case, an amount of calculation becomes enormous. Therefore, the calculation is assumed to be executed every million yen and interpolate a value therebetween linearly in the fifth embodiment (of course, it may be approximated to a curve such as curve of the second order).

The risk volume calculator 906 calculates a risk of VaR and the like and an expected value of the loss amount using the loss event rate stored in the loss event rate memory 909 and the calculated loss cumulative provability.

An example of a process procedure for a risk measure calculation is as follows.

At first, assuming that λ=an expected value of the number of event occurrences, and Poisson distribution of the parameter λ is considered.

$${p}_{k} = {ⅇ}^{- λ} \frac{{λ}^{k}}{k !}$$

An example of pk in case of λ=10 is shown in the Table 8. The accumulative provability of the Table 8 is expressed by the following equation.

$${\sum }_{i = 0}^{k} {p}_{i}$$

For example, if k=2, this means provability that the number of events is not more than two. Such a Table is prepared according to the parameter λ beforehand.

A random number generator generates real numbers from 0 to 1 at random. When a random number is x, the number of events is determined based on the Table 66. The Table 8 shows that if the accumulative provability is less than 4.53999E-05, the event is 0, if it is less than 0.000499399 and not less than 4.53999E-05, the event is 1, . . . For example, if x=0.8, the accumulative provability is not less than 0.791556476 and less than 0.864464423. Thus, the number of events is assumed to be 13.

Subsequently, the loss amounts concerning the events of losses, respectively, are set. A uniform random number is generated every number of events, and the loss amount is settled by the Table 13. Because only the massive loss is considered as an object in the fifth embodiment, the accumulative provability of less than one million yen is not settled by the Table 11. However, it can be speculated from the Table 11 that the probability that the loss is less than one million yen is 99%. Accordingly, if the value obtained by generating the uniform random number between 0-1 is not less than 0.99, the loss amount is not more than one million yen. In this case, an amount of money is set at a value u of not less than 0 and not more than one million yen. Assume u=1000 yen herein.

Concretely, if the value of the random number is 0.5, the accumulative provability is less than 0.99, so that the loss amount is 1000 yen. If the value of the random number is 0.9930, the loss amount is between five million yen and six million yen. The loss amount is assumed to be six million yen supposing the worst case herein aside from this method, a method to supplement in a linear line is thought about. In that case, this can be calculated by the following equation.

$$\frac{5 \times ( 0.993076287 - 0.993 ) + 6 \times ( 0.993 - 0.992857404 )}{0.993076287 - 0.992857404}$$

If 13 events occur, the loss amount is settled by doing a similar process for each event. The amounts of losses corresponding to the number of events are added up. For example, when the amounts of losses of 13 events are added up, for example, 15,568,000 yen are obtained.

The above process is repeated by designated times (N times). A risk measure output unit 907 sorts the N amounts of losses in the descending order, and outputs the value in the top 0.1% point as VaR of 99.9% level. The risk measure output unit 707 calculates an average of N amounts of losses and outputs it as an expected loss amount. For example, if N=one million times, the top 0.1% corresponds to the loss amount in the top 1000th. The calculated result of the loss amounts in the top 0.1% are extracted, and the expected value of the loss amounts of the extracted samples is calculated to be output as CVaR.

According to the present invention, there is provided a quantification apparatus of operational risk which can quantify operational risk of a massive loss from a few loss example, and a method.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus of quantifying operational risk, comprising:
a transaction amount input unit configured to input a transaction amount,
a loss rate density input unit configured to input a loss rate density corresponding to a probability density when setting a loss rate in a loss event to a random variable;
a massive loss density calculating unit configured to calculate a massive loss density of the loss rate density, which corresponds to an loss amount not less than a threshold, based on the transaction amount and the loss rate density; and
a risk measure calculating unit configured to calculate operational risk from the massive loss density.

2. The apparatus according to claim 1, wherein the operational risk includes one of a value-at-risk and a conditional value-at-risk.

3. The apparatus according to claim 1, which further comprises:
a calculation unit configured to obtain an cumulative provability of the loss amount based on the massive loss density;
a loss event rate input unit configured to input a loss event rate corresponding to a probability that the loss event occurs independently of the transaction amount;
a loss event generation unit configured to generate a plurality of loss events, based on a random number and the loss event rate;
a calculation unit configured to calculate the amount of loss of each of the generated loss events, based on the accumulative provability of the loss amount;
a sorting unit configured to sort the calculated amounts of losses in the descending order; and
a determination unit configured to determine a value based on the sorted losses as the operational risk.

4. The apparatus according to claim 1, which further comprises:
a small amount loss density input unit configured to input a small amount loss density corresponding to a conditional probability density when setting the loss amount to a random variable with a small amount condition that the loss amount is less than the threshold;
a compensating unit configured to compensate the small amount loss density by multiplying the small amount loss density by an augmenter based on the massive loss density; and
a calculation unit configured to calculate the loss density by combining the massive loss density and the small amount loss density, wherein the accumulative provability of the loss amount is obtained from the loss density.

5. The apparatus according to claim 4, which comprises a calculation unit configured to calculate the probability that the loss amount is less than the threshold, using the massive loss density to obtain the probability as the augmenter.

6. The apparatus according to claim 1, which comprises a multiplying unit configured to multiply the massive loss density by a ratio of a loss event rate to a massive loss event rate, the loss event rate corresponding to the probability that an event of a loss occurs independently of the transaction amount, and the massive loss event rate corresponding to a conditional probability that an event of a massive loss occurs.

7. The apparatus according to claim 6, which comprises a calculation unit configured to calculate the loss event rate from an operation quality evaluation model including an event occurrence model based on a random number.

8. The apparatus according to claim 1, wherein the massive loss density calculating unit is configured to calculate a loss rate by dividing the amount of one loss by one transaction amount, obtain a value by dividing a loss rate density corresponding to the loss rate by one transaction amount, obtain the value on each of a plurality of transaction amounts, and calculate an average of values corresponding to the plurality of transaction amounts as the massive loss density.

9. The apparatus according to claim 1, wherein in an amount-of-loss total density function wherein an amount-of-loss total during a given period of time is set to a horizontal axis, and a probability density to each amount-of-loss total value is set to a vertical axis, a percentile value of a given upper part is set to be a value of the operational risk.

10. The apparatus according to claim 1, wherein in an amount-of-loss total density function wherein an amount-of-loss total during a given period of time is set to a horizontal axis, and a probability density to each amount-of-loss total value is set to a vertical axis, an average of an amount-of-loss total not less than a percentile of a given upper part is set to be a value of the operational risk.

11. A quantification apparatus of operational risk, comprising:
a transaction amount input unit configured to input a transaction amount;
a transaction amount memory to store the input transaction amount;
a loss rate density input unit configured to input a loss rate density corresponding to a probability density when setting a loss rate in a loss event to a random variable;
a loss rate density memory to store the input loss rate density;
a massive loss density calculating unit configured to calculate a massive loss density of the loss density, which corresponds to the loss amount not less than a threshold, based on the transaction amount stored in the transaction amount memory and the loss rate density stored in the loss rate density memory;
a massive loss density memory to store the calculated massive loss density;
a risk measure calculating unit configured to calculate operational risk from the massive loss density stored in the massive loss density memory; and
an output unit configured to output calculated risk measure.

12. A method of quantifying operational risk, comprising:
inputting a transaction amount with an transaction amount input unit,
inputting a loss rate density corresponding to a probability density when setting a loss rate in a loss event to a random variable with a loss rate density input unit;
calculating a massive loss density of the loss rate density, which corresponds to an loss amount not less than a threshold, based on the transaction amount and the loss rate density, with a massive loss density calculating unit; and
calculating operational risk from the massive loss density with a risk measure calculating unit.

13. The method according to claim 12, wherein the operational risk includes one of a value-at-risk and a conditional value-at-risk.

14. The method according to claim 12, which further comprises:
obtaining an accumulative provability of the loss amount based on the massive loss density;
inputting a loss event rate corresponding to a probability that a loss event occurs independently of the transaction amount;
generating a plurality of loss events, based on a random number and a loss event rate;
calculating the amount of loss of each of the generated loss events, based on an accumulative provability of the loss amount;
sorting the calculated amounts of losses in descending order; and
determining a value selected based on the sorted losses as the operational risk.

15. The method according to claim 11, which further comprises:
inputting a small amount loss density corresponding to a conditional probability density when setting the loss amount to a random variable, with a small amount condition that the loss amount is less than the threshold;
compensating the small amount loss density by multiplying the small amount loss density by an augmenter based on the massive loss density;
calculating the loss density by combining the massive loss density and the small amount loss density; and
obtaining the accumulative provability of the loss amount from the loss density.

16. The apparatus according to claim 15, which comprises calculating the probability that the loss amount is less than the threshold, using the massive loss density to obtain the probability as the augmenter.

17. The method according to claim 15, which comprises multiplying the massive loss density calculated by the massive loss density calculating unit by a ratio of a loss event rate corresponding to the probability that an event of a loss occurs to a massive loss event rate corresponding to the conditional probability that an event of a massive loss occurs independently of the transaction amount,

18. The method according to claim 17, which comprises calculating the loss event rate from an operation quality evaluation model including an event occurrence model based on a random number.

19. The method according to claim 12, wherein the massive loss density calculating includes:
calculating a loss rate by dividing the amount of one loss by one transaction amount;
obtaining a value by dividing a loss rate density corresponding to the loss rate by the one transaction amount;
obtaining the value on each of a plurality of transaction amounts; and
calculating an average of values corresponding to the plurality of transaction amounts as the massive loss density.

20. A program stored in a computer readable medium for quantifying operational risk, comprising:
means for instructing a computer to input a transaction amount,
means for instructing the computer to input a loss rate density corresponding to a probability density when setting a loss rate in a loss event to a random variable;
means for instructing the computer to calculate a massive loss density of the loss rate density, which corresponds to an loss amount more than a threshold, based on the transaction amount and the loss rate density; and
means for instructing the computer to calculate operational risk from the massive loss density calculated.
